(19) United States
(12) Patent Application Publication
(10) Pub. No.: US 2012/0065050 A1
(43) Pub. Date: Mar. 15, 2012

(54) STRUCTURAL OR DEDCORATION ELEMENT AND MANUFACTURING METHOD THEREOF

(75) Inventor: Emmi Nieminen, Tampere (FI)

(73) Assignee: SUOMEN LASINJALOSTUS OY, Tampere (FI)

(21) Appl. No.: 13/263,064

(22) PCT Filed: Apr. 16, 2010
(86) PCT No.: PCT/FI10/50308

§ 371 Date: Nov. 15, 2011

(30) Foreign Application Priority Data
Jun. 3, 2009 (FI) U20090214

(51) Int. Cl. C03C 14/00

(52) U.S. Cl. 501/32

(57) ABSTRACT

A structural or decorative article (1), having its body consisting of a light-permeable casting material with crushed (2) or glass grit contained therein.

The invention relates to details of decorative articles, especially those of lamp-containing building bricks or decorative light fixtures.

Prior known are garden lights of glass or plastics and glass bricks, involving the use of LED lights. Also known are glass surface floor or wall tiles with an integrated LED light.

An object of the invention is to produce more reasonably priced and visually pleasant building, interior or decorative elements. A second object of the invention is to enhance the use of recycled crushed glass. A third object of the invention is to improve the strength and durability of cast free-form structural or decorative pieces for example in comparison to prior known tiles of glass or plastics or glass bricks.

The objective of the invention is achieved with an article according to the first claim, wherein a light permeable casting mass is admixed with crushed glass or the like glass grit or flakes. In addition, the invention relates to a method as set forth in claim 6 for the fabrication of articles.

Prior known examples of a garden light include for example “stones” of plastic or glass with an LED light fitted inside. Glass is a highly weather-resistant and highly light-permeable material, yet it is comparatively expensive to produce in small series because of high mold expenses. Glass is also easily shattered on impact. Plastic, on the other hand, is more expensive than glass as a raw material, and the compression strength of plastics is poor, for example on roadway. Under the wheel of a car, for example, a block of plastics gives way to the extent that in-block electric components become strained and the plastic material itself becomes fatigued in long-term stress. Transparent or translucent grades of plastic capable of low temperature casting without a high pressure are relatively expensive. Therefore, for example pieces to be cast for garden decoration are expensive when manufactured with cheap molds, and inexpensive thermoplastic materials require expensive molds, which is why making a small series of decorative objects from plastic is not economically sensible for cost reasons. Glass, on the other hand, is vulnerable to shattering, the fabrication of small series of glass objects being particularly expensive because of mold or labor expenses.

According to the invention, crushed glass is used within transparent or translucent casting resin, the crushed glass providing a major increase in the rigidity and compression strength of an article. At the same time, depending on a difference between the refractive indices of casting resin and glass, a visually appropriate effect is provided. In the event that the refractive indices differ from one another, the light deflects at the phase boundary of casting mass and glass fragments, the block resembling crushed ice in terms of its visual appearance. The crushed glass or the casting material can be colored, or the casting material may contain an opacity-enhancing additive, for example glass dust or glass beads. The casting material can further have air or gas bubbles intentionally incorporated therein, said bubbles scattering the lamp's light. With respect to glass tiles, the present invention provides a major saving of energy, and the use of crushed glass also saves plastic material.

The invention will now be described more closely with reference to the accompanying drawing, in which:

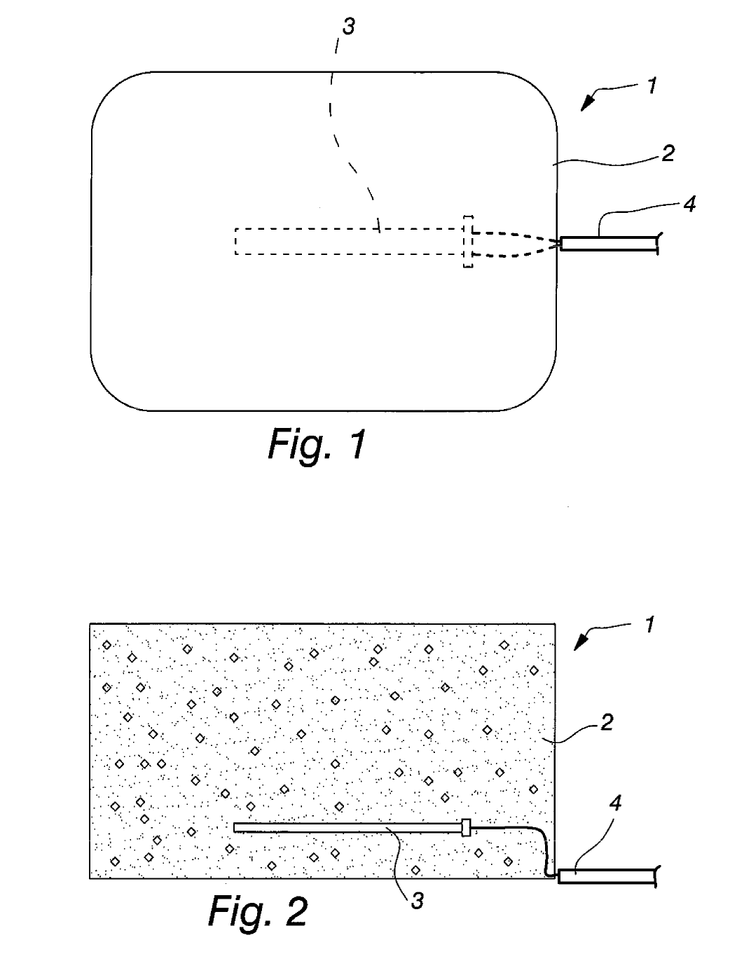

FIG. 1 shows one embodiment of the invention in a schematic plan view, and

FIG. 2 shows the embodiment of FIG. 1 in cross-section.

An illuminated “glass stone” 1, depicted in FIGS. 1 and 2, comprises aggregate consisting of crushed glass 2 within transparent or translucent casting resin.

Within the cast is disposed a ribbon-like led light 3, which is connectible to an external power supply by means of a wire 4.

The casting resin may consist for example of a thermoplastic material, such as polyethylene, or a thermosetting plastic, such as epoxy. The use of a high temperature melting plastic may necessitate that the LED light be installed non-homogeneously, i.e. the casting mass can be formed with a cavity for the light fixture and the cavity is filled for example with a silicone mass after installation of the light fixture. The cavity is preferably formed with its opening towards a bottom of the casting mass. The LED light may also be glued or taped e.g. to the bottom part of a previously cast article, followed by pouring a desired casting resin on top of it. In this case, the light fixture may also have its backdrop in the form of a reflector, for example a high-gloss tape or a metal reflector for improved cooling. The two-part casting is preferably conducted in such a way that the light fixture and the electronics possibly relevant to the light fixture are installed within a cavity formed in the bottom of a first-to-be cast article, and then the cavity is filled up with a second casting. As a result, the composite of crushed glass and casting mass establishes a rigid body around the light fixture and the post-fill casting can be conducted by using mass of a lesser compression strength, even butyl rubber or silicone. This also enables the use of one and the same cast article with light fixtures of various colors and various intensities. Moreover, the cavity can accommodate a battery or electronics, for example for remote control or charging based on solar cells.

In the event that decorative objects of the invention are produced in small series or even in the form of unique pieces, use is preferably made of a room temperature setting thermoplastic, for example epoxy. In this case, the mold can be first filled with crushed glass, and the casting is then performed by injecting or pouring the casting plastic into the mold. The grit size of crushed glass is preferably selected, such that the crushed material fills most of the mold volume, whereby the required amount of epoxy is less than a half of the mold volume and the amount of crushed glass is more than a half of the mold volume. The degree of fullness obtained by the crushed material can be improved by using a crushed material with fragments of various sizes and, for example, by giving the mold a pre-cast shaking for compacting and interspersing the fragments. Thus, small fragments fill up the spaces left between larger fragments. The grit size of crushed glass is preferably more than 3 mm, e.g. 3-12 mm, or even more than 15 mm. The crushed glass can make up as much as 90% of the volume, but preferably there is about 80% of crushed glass and about 20% of resin.

The casting can be conducted by injecting the casting plastic from the bottom upwards, thus reducing the creation of cavities produced by air bubbles as the pieces of glass become wet in a more consistent fashion with the surface rising from the bottom. In addition, the crushed glass can be pretreated with an agent capable of improving the adhesion of plastics and promoting the wetting of crushed glass surface. Epoxy, some acrylates and grades of silicone plastics can be cast cost-effectively even into a disposable mold as resistance to pressure or heat is not necessary. The mold may consist, for example, of silicone rubber, thus enabling a reproduction of the shape of even a single article and enabling a disengagement and reuse of the mold as the mold stretches and allows a removal of the article. If it is desirable for glass fragments not to sink beyond the surface defined by a soft mold, the mold can be first cast for a thin internal lining and only after its hardening is crushed glass placed in the mold.

In certain application, on the other hand, it is beneficial if the crushed glass sinks inside within a slightly yielding mold and produces glass ribs protruding slightly from the finished surface. This is a simple way of improving the friction properties of an article to be laid on a roadway. The resulting friction surface is also visually attractive, for example in comparison to a subsequently added coarse aggregate top. Also, the friction surface has a better wear resistance than a coarse aggregate-epoxy coating. Thus, it is possible to produce durable-surface transparent illuminating tiles without needing a separate friction coating for neutralizing wet slipperiness. Because the crushed glass extends from the surface deep into the tile, the friction coating does not become easily worn or detached. The result is a wear resistant tile or for example an illuminating floor element for a bathroom or shower cabinet. Furthermore, despite its relatively modest intensity, the LED light in outdoor service is nevertheless capable of melting or removing ice from the element's surface, making it easy to remove ice and snow from top of the illuminated tile. The LED emits light and thermal radiation, which is absorbed and becomes heat at the phase boundary of ice and plastics. The crushed glass also directs light in such a way that the radiation intensity is higher at the protruding points of crushed material. Thereby, the surface-fixed ice is subjected to localized warming, making it even easier to keep the surface clear of ice. In addition, the combination of crushed glass and plastics is more resistant to abrasion than plastics alone, its friction properties on a roadway, especially on a wet one, are better than those of glass or plastics separately, and the removal of ice from the element's surface is easy because ice has poor adherence to an appropriately selected type of plastic, nor is the adherence of ice significantly increased by the edges of crushed glass protruding just slightly from the surface.

The structural or decorative article according to the invention is preferably a yard stone, an interior element or tile, or a floor tile. The article according to the invention is also suitable for use as an outdoor light fixture, e.g. as a light fixture to be laid on a roadway. The article according to the invention may also be a garden or water feature ornament.

The article according to the invention contains crushed glass in the amount of 20-90% of its volume, preferably about 70-90% of its volume. In tile-shaped article, the crushed material may also be at the surface in a relatively organized form for a mosaic type surface pattern. Casting can also be performed in layers for possibly creating visual effects, whereby, for example, crushed glass for the surface of a tile-shaped article can be first cast in an opal or even dark casting mass and the rear side can be cast with a light-permeable coating, by way of with illumination can be provided through pieces of crushed glass. The result is an illuminating mosaic effect. The surface appearance can be changed by changing the colors cast layers or the colors of LED lamps or some other light fixture set in the backdrop.

The actual casting can be conducted not only by first filling the mold with crushed glass and by pouring casting material to fill the void remaining between bits of crushed material, but also by adding crushed glass in a running casting material in the mould or by mixing, prior to the casting process, the crushed glass and the casting material with each other in a molten or solid state. The casting may also be conducted as slip casting or nozzle casting, whereby the article can be an extruded or rolled profile or sheet. The rolling can be performed by means of glass crushing rolls, whereby the glass can also be crushed for a layer of appropriate thickness as late as during the casting process. If a thermoplastic casting material is used, some casting material can be admixed in amongst the glass also before crushing, whereby the casting material is melted after rolling and at the same time the same or another type casting material can be used for filling the void left between pieces of glass. The addition of another type of material in connection with a melting process to the surface of an article enables providing visual and functional effects, for example color variations, or enables adjusting surface properties for example by admixing fillers within the surface layer.

1-6. (canceled)

7. A structural or decorative article, wherein the article has a body comprising of a light-permeable casting material with crushed glass or glass grit contained therein.

8. An article as set forth in claim 7, wherein the crushed glass is colored or colorless recycled glass.

9. An article as set forth in claim 7, wherein the article further comprises a light fixture.

10. An article as set forth in claim 9, wherein the light fixture comprises an LED lamp.

11. An article as set forth in claim 7, wherein the crushed glass makes up not less than 50% of the article's volume.

12. An article as set forth in claim 11, wherein the crushed glass makes up not less than 70% of the article's volume.

13. A method for the fabrication of structural or decorative articles, wherein the method comprises casting or press-forming crushed glass and a light-permeable casting material.
